(19) United States
(12) Patent Application Publication
(10) Pub. No.: US 2021/0371626 A1
(43) Pub. Date: Dec. 2, 2021

(54) VIBRATION ISOLATION RUBBER COMPOSITION AND VIBRATION ISOLATION RUBBER MEMBER

(71) Applicant: Sumitomo Riko Company Limited, Aichi (JP)

(72) Inventors: Masashi OKAHISA, Aichi (JP); Seiji KASAI, Aichi (JP)

(73) Assignee: Sumitomo Riko Company Limited, Aichi (JP)

(21) Appl. No.: 17/400,118

(22) Filed: Aug. 12, 2021

Related U.S. Application Data
(63) Continuation of application No. PCT/JP2021/007966, filed on Mar. 2, 2021.

(30) Foreign Application Priority Data
Mar. 26, 2020 (JP) 2020-055853

(51) Int. Cl. C08L 7/00; C08K 3/04; C08K 3/36; C08K 5/25; C08K 5/378; C08K 5/45

(52) U.S. Cl. CPC C08L 7/00; C08K 3/04; C08K 3/36; C08L 2201/08; C08K 5/378; C08K 5/45; C08K 5/25

(57) ABSTRACT

A vibration isolation rubber composition containing the following components (B) to (E) together with a rubber compound made of the following (A) is produced, which makes it possible to highly satisfy both heat resistance and the reduction of dynamic magnification factors. The vibration isolation rubber composition containing (A) a diene-based rubber containing natural rubber as a main component, (B) a filler, (C) a hydrazide compound, (D) a disulfide compound represented by General Formula (1), and (E) a sulfur-based vulcanizing agent.

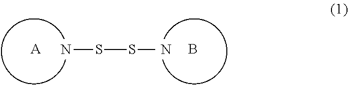

[In General Formula (1), a ring A and a ring B each indicate a nitrogen-containing heterocyclic group having 4 to 24 carbon atoms.]

### CROSS-REFERENCE TO RELATED APPLICATIONS

This application is a continuation application of International Application number PCT/JP2021/007966, filed on Mar. 2, 2021, which claims the priority benefit of Japan Patent Application No. 2020-055853 filed on Mar. 26, 2020. The entirety of each of the above-mentioned patent applications are hereby incorporated by reference herein and made a part of this specification.

### BACKGROUND

### Technical Field

The present disclosure relates to a vibration isolation rubber composition and a vibration isolation rubber member that are used for vibration isolation applications in vehicles such as automobiles and trains.

### Related Art

In the technical field of vibration isolation rubber, there is a demand for the reduction of dynamic magnification factors (decreasing the value of the dynamic magnification factor [dynamic spring constant (Kd)/static spring constant (Ks)]) or the like in order for high durability or enhancement of quietness.

In such a circumstance, there is a proposal of methods for reducing dynamic magnification factors or the like by adding a hydrazide compound to a rubber composition (for example, refer to Patent Literature 1 and 2).

### CITATION LIST

### Patent Literature

### [Patent Literature 1]

Japanese Patent Laid-Open No. 2010-121082

### [Patent Literature 2]

Japanese Patent Laid-Open No. 2001-172435

Incidentally, for vibration isolation rubber, there is another demand for heat resistance in consideration of uses in extremely hot places or the like. In the related art, diene-based rubber such as natural rubber is used as a polymer for vibration isolation rubber, and it is common to use sulfur-based vulcanizing agents as a vulcanizing agent therefor, but such vibration isolation rubber has a problem with heat resistance.

Usually, reduction of sulfur is effective for improving the heat resistance of such vibration isolation rubber, but the reduction of sulfur brings about the deterioration of durability or dynamic magnification factors.

Therefore, in the related art, there has been a demand for both heat resistance and the reduction of dynamic magnification factors being highly satisfied while maintaining durability, but it is the current status that simply adding a hydrazide compound to a rubber composition as in the above-described patent literature does not sufficiently solve the problem.

The present disclosure has been made in consideration of such a circumstance, and an objective of the present disclosure is to provide a vibration isolation rubber composition and a vibration isolation rubber member that are capable of highly satisfying both heat resistance and the reduction of dynamic magnification factors.

### SUMMARY

The present inventors repeated intensive studies to solve the above-described problem. In the process of the studies, it was recalled that, in sulfur vulcanization-based vibration isolation rubber compositions containing, as a rubber component, a diene-based rubber in which a natural rubber is a main component, a specific disulfide compound having nitrogen-containing heterocyclic groups at both terminals is jointly used with a hydrazide compound. When the specific disulfide compound is used in combination with the hydrazide compound, a cleavage reaction of the disulfide is likely to occur. In addition, it was ascertained that, since the disulfide compound that has accelerated the cleavage reaction as described above is capable of efficiently forming a crosslink of a monosulfide or disulfide in the natural rubber, it is possible to improve the heat resistance while suppressing the deterioration of the durability or the dynamic magnification factor to the minimum extent. Furthermore, it was found that the dynamic magnification factor can also be reduced with the hydrazide compound, which makes it possible to achieve a desired objective.

That is, the gist of the present disclosure is the following [1] to [12].

[1] A vibration isolation rubber composition containing components (B) to (E) below together with a rubber compound made of (A) below.

(A) A diene-based rubber containing a natural rubber as a main component.

(B) A filler.

(C) A hydrazide compound.

(D) A disulfide compound represented by General Formula (1).

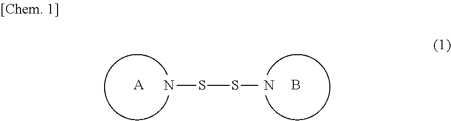

[In General Formula (1), a ring A and a ring B each indicate a nitrogen-containing heterocyclic group having 4 to 24 carbon atoms.]

(E) A sulfur-based vulcanizing agent.

[2] The vibration isolation rubber composition according to [1], in which a content fraction of the hydrazide compound (C) is within a range of 0.01 to 5.0 parts by weight with respect to 100 parts by weight of the diene-based rubber (A).
[3] The vibration isolation rubber composition according to [1] or [2], in which a content fraction of the disulfide compound (D) is within a range of 0.3 to 5.0 parts by weight with respect to 100 parts by weight of the diene-based rubber (A).
[4] The vibration isolation rubber composition according to any one of [1] to [3], in which a weight ratio (C:D) between the hydrazide compound (C) and the disulfide compound (D) is 1:60 to 50:1.
[5] The vibration isolation rubber composition according to any one of [1] to [4], in which the hydrazide compound (C) is a dihydrazide compound represented by General Formula (2).

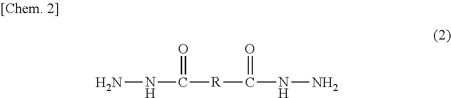

[In General Formula (2), R represents an alkylene group having 1 to 30 carbon atoms, a cycloalkylene group having 3 to 30 carbon atoms, or a phenylene group.]
[6] The vibration isolation rubber composition according to any one of [1] to [4], in which the hydrazide compound (C) is at least one selected from adipic acid dihydrazide and isophthalic dihydrazide.
[7] The vibration isolation rubber composition according to any one of [1] to [6], in which the disulfide compound (D) is at least one selected from 4,4′-dithiodimorpholine and dithiodicaprolactam.
[8] The vibration isolation rubber composition according to any one of [1] to [7], in which a content fraction of the filler (B) is within a range of 5 to 100 parts by weight with respect to 100 parts by weight of the diene-based rubber (A).
[9] The vibration isolation rubber composition according to any one of [1] to [8], in which the filler (B) is at least one selected from the group consisting of carbon black and silica.
[10] The vibration isolation rubber composition according to any one of [1] to [8], in which the filler (B) is FEF-class carbon black.
[11] The vibration isolation rubber composition according to any one of [1] to [8], in which the filler (B) is made up of carbon black and silica, and a weight ratio between carbon black and silica is 8:2 to 2:8.
[12] A vibration isolation rubber member that is made of a vulcanized body of the vibration isolation rubber composition according to any one of [1] to [11].

### DESCRIPTION OF THE EMBODIMENTS

Based on the above-described gist, the vibration isolation rubber composition of the present disclosure is capable of highly satisfying both heat resistance and the reduction of dynamic magnification factors.

Next, an embodiment of the present disclosure will be described in detail.

However, the present disclosure is not limited to this embodiment.

As described above, a vibration isolation rubber composition of the present disclosure contains the following components (B) to (E) together with a rubber compound made of the following (A).

(A) A diene-based rubber containing a natural rubber as a main component.

(B) A filler.

(C) A hydrazide compound.

(D) A disulfide compound represented by General Formula (1).

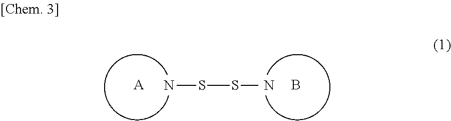

[In General Formula (1), a ring A and a ring B each indicate a nitrogen-containing heterocyclic group having 4 to 24 carbon atoms.]

(E) A sulfur-based vulcanizing agent.

### [Diene-Based Rubber (A)]

As described above, in the vibration isolation rubber composition of the present disclosure, a diene-based rubber (A) containing a natural rubber (NR) as a main component is used as a rubber component. Here, the “main component” indicates that 50% by weight or more of the diene-based rubber (A) is the natural rubber and intends to mean that the diene-based rubber (A) may be made of the natural rubber alone. A natural rubber is contained as the main component as described above, which makes the diene-based rubber excellent in terms of strength and the reduction of the dynamic magnification factor.

In addition, examples of diene-based rubbers other than natural rubber include butadiene rubber (BR), styrene-butadiene rubber (SBR), chloroprene rubber (CR), isoprene rubber (IR), acrylonitrile-butadiene rubber (NBR), ethylene-propylene-diene rubber (EPDM), butyl rubber (IIR), and the like. These diene-based rubbers may be singly used or two or more diene-based rubbers may be jointly used. Among them, butadiene rubber (BR) and isoprene rubber (IR) are capable of exhibiting excellent vibration isolation performance when jointly used with natural rubber and are thus more preferable.

### [Filler (B)]

As the filler (B), carbon black, silica, calcium carbonate, or the like is singly used or two or more thereof are jointly used. Carbon black and silica are preferable. Among both, carbon black is more preferable from the viewpoint of vibration properties. In addition, 50% by weight or more of the filler (B) is desirably carbon black, and 90% by weight or more of the filler (B) is more desirably carbon black.

As the carbon black, for example, a variety of classes of carbon black such as an SAF class, an ISAF class, an HAF class, an MAF class, an FEF class, a GPF class, an SRF class, an FT class, and an MT class are used. Carbon black may be singly used or two or more kinds of carbon black may be jointly used. Among them, FEF-class carbon black is preferably used from the viewpoint of vibration properties and fatigue resistance. In addition, from the viewpoint of the durability and the reduction of the dynamic magnification factor, the carbon black preferably has an iodine adsorption number of 10 to 110 mg/g and a dibutyl phthalate oil absorption number (DBP oil absorption number) of 20 to 180 ml/100 g.

It should be noted that the iodine adsorption number of the carbon black is a value measured based on JIS K 6217-1 (A method). In addition, the DBP adsorption number of the carbon black is a value measured based on JIS K 6217-4.

As the silica, for example, wet silica, dry silica, colloidal silica, or the like is used. In addition, silica may be singly used or two or more kinds of silica may be jointly used.

In addition, from the viewpoint of achieving higher durability, additional reduction of the dynamic magnification factor, or the like, the BET specific surface area of the silica is preferably 50 to 320 m²/g and more preferably 70 to 230 m²/g.

It should be noted that the BET specific surface area of the silica can be measured, for example, using a gas mixture (N₂: 70% and He: 30%) as an adsorption gas and a BET specific surface area measuring instrument (manufactured by Micro Data Co., Ltd., 4232-II) after degassing a sample at 200° C. for 15 minutes.

It should be noted that, in a case where only carbon black and silica are jointly used as the filler (B), regarding the fractions thereof, carbon black and silica are preferably contained at fractions of 8:2 to 2:8 in terms of the weight ratio from the viewpoint of the fatigue resistance. From the same viewpoint, in the above-described case, carbon black and silica are more preferably contained at fractions of 4:6 to 2:8, and carbon black and silica are still more preferably contained at fractions of 3:7 to 2:8.

In addition, from the viewpoint of the fatigue resistance, the content of the entire filler (B) is preferably within a range of 5 to 100 parts by weight, more preferably within a range of 10 to 80 parts by weight, and still more preferably within a range of 15 to 75 parts by weight with respect to 100 parts by weight of the diene-based rubber (A).

### [Hydrazide Compound (C)]

As the hydrazide compound (C), a monohydrazide compound, a dihydrazide compound, and the like may be singly used or two or more thereof may be jointly used.

Among them, a dihydrazide compound represented by General Formula (2) is preferably used since it is possible to improve the dispersibility of the filler (B) and to effectively suppress an increase in the dynamic magnification factor.

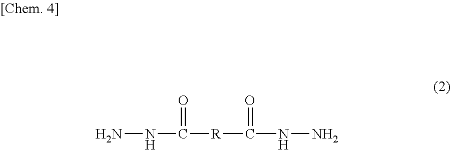

[In General Formula (2), R represents an alkylene group having 1 to 30 carbon atoms, a cycloalkylene group having 3 to 30 carbon atoms, or a phenylene group.]

In General Formula (2), R is preferably an alkylene group having 4 to 12 carbon atoms or a phenylene group.

Here, specific examples of the monohydrazide compound include propionic acid hydrazide, thiocarbohydrazide, stearic acid hydrazide, salicylic hydrazide, 3-hydroxy-2-naphthoic acid hydrazide, p-toluenesulfonyl hydrazide, aminobenzohydrazide, 4-pyridinecarboxylic acid hydrazide, and the like. These monohydrazide compounds may be singly used or two or more monohydrazide compounds may be jointly used. Among them, 3-hydroxy-2-naphthoic acid hydrazide is preferable from the viewpoint of the reduction of the dynamic magnification factor.

In addition, specific examples of the dihydrazide compound include adipic acid dihydrazide, isophthalic acid dihydrazide, phthalic acid dihydrazide, terephthalic acid dihydrazide, succinic acid dihydrazide, azelaic acid dihydrazide, sebacic acid dihydrazide, oxalic acid dihydrazide, dodecanoic acid dihydrazide, and the like. These dihydrazide compounds may be singly used or two or more dihydrazide compounds may be jointly used. Among them, adipic acid dihydrazide and isophthalic acid dihydrazide are preferable from the viewpoint of the reduction of the dynamic magnification factor.

From the viewpoint of the reduction of the dynamic magnification factor or the like, the content of the hydrazide compound (C) is preferably 0.01 to 5.0 parts by weight, more preferably 0.1 to 5.0 parts by weight, and still more preferably within a range of 0.3 to 3.0 parts by weight with respect to 100 parts by weight of the diene-based rubber (A).

### [Disulfide Compound (D)]

As the disulfide compound (D), a disulfide compound represented by General Formula (1) is used.

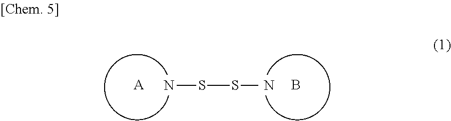

[In General Formula (1), a ring A and a ring B each indicate a nitrogen-containing heterocyclic group having 4 to 24 carbon atoms.]

In General Formula (1), the ring A and the ring B may be identical to or different from each other. In addition, the ring A and the ring B are each a nitrogen-containing heterocyclic group having 4 to 24 carbon atoms as described above, preferably a nitrogen-containing heterocyclic group having 4 to 20 carbon atoms, and more preferably a nitrogen-containing heterocyclic group having 4 to 16 carbon atoms.

Examples of the disulfide compound (D) include 4,4′-dithiodimorpholine (DTDM) represented by Chemical Formula (1-1), dithiodicaprolactam (DTDC) represented by Chemical Formula (1-2), and the like. These disulfide compounds may be singly used or two or more disulfide compounds may be jointly used. Among them, 4,4′-dithiodimorpholine and dithiodicaprolactam are preferable from the viewpoint of the heat resistance or the like.

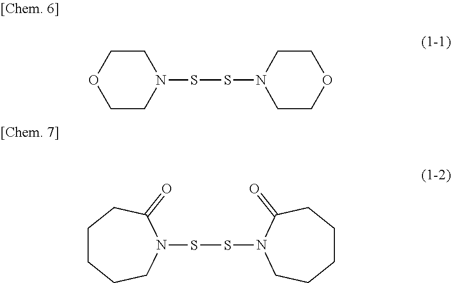 [SMILES: C1CN(SSN2CCOCC2)CCO1 ; O=C1CCCCCN1SSN1CCCCCC1=O]

It should be noted that, regarding the fractions of the hydrazide compound (C) and the disulfide compound (D), the hydrazide compound (C) and the disulfide compound (D) are preferably contained at fractions of 1:60 to 50:1 in terms of the weight ratio from the viewpoint of solving the problem of the present disclosure. From the same viewpoint, the hydrazide compound (C) and the disulfide compound (D) are more preferably contained at fractions of 1:4 to 50:3, and the hydrazide compound (C) and the disulfide compound (D) are still more preferably contained at fractions of 1:4 to 10:1.

From the viewpoint of solving the problem of the present disclosure, the content of the disulfide compound (D) is preferably 0.3 to 5.0 parts by weight, more preferably 0.5 to 5.0 parts by weight, and still more preferably within a range of 0.5 to 3.0 parts by weight with respect to 100 parts by weight of the diene-based rubber (A).

### [Sulfur-Based Vulcanizing Agent (E)]

Examples of the sulfur-based vulcanizing agent (E) include compounds containing sulfur such as powdered sulfur, precipitated sulfur, or insoluble sulfur (however, disulfide compounds containing the component (D) or compounds that do not function as a vulcanizing agent (vulcanization accelerators, vulcanization assistants, and the like) are excluded), and the like. These sulfur-based vulcanizing agents may be singly used or two or more sulfur-based vulcanizing agents may be jointly used.

In addition, the content of the sulfur-based vulcanizing agent (E) is preferably within a range of 0.05 to 5 parts by weight, more preferably within a range of 0.3 to 3.5 parts by weight, and still more preferably within a range of 0.5 to 3 parts by weight with respect to 100 parts by weight of the diene-based rubber (A). This is because, when the content of the sulfur-based vulcanizing agent (E) is too low, a tendency for the vulcanization responsiveness to become poor appears, and, conversely, when the content of the sulfur-based vulcanizing agent (E) is too high, a tendency for the physical properties (breaking strength and elongation at breaking) of rubber to deteriorate appears.

It should be noted that, in the vibration isolation rubber composition of the present disclosure, it is also possible to appropriately contain a silane coupling agent, a vulcanization accelerator, a vulcanization assistant, an anti-aging agent, a process oil, or the like as necessary together with the components (A) to (E), which are the essential components.

Examples of the silane coupling agent include a mercapto-based silane coupling agent, a sulfide-based silane coupling agent, an amine-based silane coupling agent, an epoxy-based silane coupling agent, a vinyl-based silane coupling agent, and the like. These silane coupling agents may be singly used or two or more silane coupling agents may be jointly used. Among them, the silane coupling agent is preferably a mercapto-based silane coupling agent or a sulfide-based silane coupling agent since the vulcanization density increases, and the silane coupling agent becomes particularly effective for a low dynamic magnification factor and durability.

Examples of the mercapto-based silane coupling agent include 3-mercaptopropyltrimethoxysilane, 3-mercaptopropyltriethoxysilane, and the like. These mercapto-based silane coupling agents may be singly used or two or more mercapto-based silane coupling agents may be jointly used.

Examples of the sulfide-based silane coupling agent include bis-(3-(triethoxysilyl)-propyl)-disulfide, bis(3-triethoxysilylpropyl)trisulfide, bis-(3-(triethoxysilyl)-propyl)-tetrasulfide, bis(3-trimethoxysilylpropyl)disulfide, bis(2-triethoxysilylethyl)tetrasulfide, bis(2-trimethoxysilylethyl)tetrasulfide, bis(3-triethoxysilylpropyl)disulfide, 3-trimethoxysilylpropyl-N,N-dimethylthiocarbamoyltetrasulfide, 3-triethoxysilylpropyl-N,N-dimethylthiocarbamoyltetrasulfide, 2-triethoxysilylethyl-N,N-dimethylthiocarbamoyltetrasulfide, 2-trimethoxysilylethyl-N,N-dimethylthiocarbamoyltetrasulfide, 3-trimethoxysilylpropylbenzothiazolyltetrasulfide, 3-triethoxysilylpropylbenzothiazoletetrasulfide, 3-triethoxysilylpropylmethacrylate monosulfide, 3-trimethoxysilylpropylmethacrylate monosulfide, and the like. These sulfide-based silane coupling agents may be singly used or two or more sulfide-based silane coupling agents may be jointly used.

Examples of the amine-based silane coupling agent include 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, 3-(N-phenyl)aminopropyltrimethoxysilane, and the like. These amine-based silane coupling agents may be singly used or two or more amine-based silane coupling agents may be jointly used.

Examples of the epoxy-based silane coupling agent include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-glycidoxypropylmethyldimethoxysilane, and the like. These epoxy-based silane coupling agents may be singly used or two or more epoxy-based silane coupling agents may be jointly used.

Examples of the vinyl-based silane coupling agent include vinyltriethoxysilane, vinyltrimethoxysilane, vinyltris(β-methoxyethoxy)silane, vinyldimethylchlorosilane, vinyltrichlorosilane, vinyltriisopropoxysilane, vinyltris(2-methoxyethoxy)silane, and the like. These vinyl-based silane coupling agents may be singly used or two or more vinyl-based silane coupling agents may be jointly used.

The content of the silane coupling agent is preferably 0.5 to 20 parts by weight and more preferably 1.0 to 10 parts by weight with respect to 100 parts by weight of the diene-based rubber (A) since the silane coupling agent is excellent for a low dynamic magnification factor, the durability, and the like.

Examples of the vulcanization accelerator include a thiazole-based vulcanization accelerator, a sulfenamide-based vulcanization accelerator, a thiuram-based vulcanization accelerator, an aldehyde ammonia-based vulcanization accelerator, an aldehyde amine-based vulcanization accelerator, a guanidine-based vulcanization accelerator, a thiourea-based vulcanization accelerator, and the like. These vulcanization accelerators may be singly used or two or more vulcanization accelerators may be jointly used. Among these, a sulfenamide-based vulcanization accelerator is preferable since the sulfenamide-based vulcanization accelerator is excellent for the crosslinking responsiveness.

In addition, the content of the vulcanization accelerator is preferably within a range of 0.1 to 10 parts by weight and particularly preferably within a range of 0.3 to 5 parts by weight with respect to 100 parts by weight of the diene-based rubber (A).

Examples of the thiazole-based vulcanization accelerator include dibenzothiazyl disulfide (MBTS), 2-mercaptobenzothiazole (MBT), sodium 2-mercaptobenzothiazole (NaMBT), zinc salt 2-mercaptobenzothiazole (ZnMBT), and the like. These thiazole-based vulcanization accelerators may be singly used or two or more thiazole-based vulcanization accelerators may be jointly used.

Examples of the sulfenamide-based vulcanization accelerator include N-oxydiethylene-2-benzothiazole sulfenamide (NOBS), N-cyclohexyl-2-benzothiazole sulfenamide (CBS), N-t-butyl-2-benzothiazole sulfenamide (BBS), N,N′-dicyclohexyl-2-benzothiazole sulfenamide, and the like. These sulfenamide-based vulcanization accelerators may be singly used or two or more sulfenamide-based vulcanization accelerators may be jointly used.

Examples of the thiourea-based vulcanization accelerator include tetramethylthiuram disulfide (TMTD), tetraethylthiuram disulfide (TETD), tetrabutylthiuram disulfide (TBTD), tetrakis(2-ethylhexyl)thiuram disulfide (TOT), tetrabenzylthiuram disulfide (TBzTD), and the like. These thiourea-based vulcanization accelerators may be singly used or two or more thiourea-based vulcanization accelerators may be jointly used.

Examples of the vulcanization assistant include stearic acid, magnesium oxide, and the like. These vulcanization assistants may be singly used or two or more vulcanization assistants may be jointly used.

In addition, the content of the vulcanization assistant is preferably within a range of 0.1 to 10 parts by weight and particularly preferably within a range of 0.3 to 7 parts by weight with respect to 100 parts by weight of the diene-based rubber (A).

Examples of the anti-aging agent include a carbamate-based anti-aging agent, a phenylenediamine-based anti-aging agent, a phenolic anti-aging agent, a diphenylamine-based anti-aging agent, a quinoline-based anti-aging agent, an imidazole-based anti-aging agent, waxes, and the like. These anti-aging agents may be singly used or two or more anti-aging agents may be jointly used.

In addition, the content of the anti-aging agent is preferably within a range of 0.5 to 15 parts by weight, more preferably within a range of 1 to 10 parts by weight, and particularly preferably within a range of 1 to 8 parts by weight with respect to 100 parts by weight of the diene-based rubber (A).

Examples of the process oil include a naphthenic oil, a paraffin-based oil, an aroma-based oil, and the like. These process oils may be singly used or two or more process oils may be jointly used.

In addition, the content of the process oil is preferably within a range of 1 to 35 parts by weight, more preferably within a range of 3 to 30 parts by weight, and particularly preferably within a range of 3 to 20 parts by weight with respect to 100 parts by weight of the diene-based rubber (A).

### [Method for Preparing Vibration Isolation Rubber Composition]

Here, the vibration isolation rubber composition of the present disclosure can be prepared by kneading the components (A) to (E), which are the essential components, and, as necessary, other materials listed above using a kneading machine such as a kneader, a Banbury mixer, an open roll, or a twin-screw agitator. Particularly, it is preferable to knead all of the materials except the vulcanization accelerator and the vulcanization assistant at the same time and then add the vulcanization accelerator and the vulcanization assistant.

An intended vibration isolation rubber member (vulcanized body) can be produced by molding the vibration isolation rubber composition of the present disclosure obtained as described above using a mold by injection molding or the like at high temperatures (150° C. to 170° C.) for 5 to 30 minutes.

In addition, the vibration isolation rubber member made of the vulcanized body of the vibration isolation rubber composition of the present disclosure is preferably used as configuration members such as engine mounts, stabilizer bushes, suspension bushes, motor mounts, subframe mounts, and the like that are used for the vehicles of automobiles or the like. Particularly, due to a low dynamic magnification factor and excellent heat resistance or durability, the vibration isolation rubber member can be advantageously used in the applications of configuration members (vibration isolation rubber members for electric vehicles) such as motor mounts, suspension bushes, and subframe mounts for electric vehicles including an electric motor as a power source (not only electric vehicles (EVs) but also fuel cell vehicles (FCV), plug-in hybrid vehicles (PHV), hybrid vehicles (HV), and the like).

Additionally, in addition to the above-described applications, the vibration isolation rubber member can also be used in the applications of vibration control apparatuses and seismic isolation apparatuses such as vibration control dampers for computer hard disks, vibration control dampers for general household appliances such as washing machines, vibration control walls for buildings in the construction and housing field, and vibration control dampers.

### EXAMPLES

Next, examples will be described together with comparative examples.

However, the present disclosure is not limited to these examples.

First, prior to the examples and the comparative examples, materials described below were prepared.

### [NR]

Natural rubber

### [IR]

NIPOL IR 2200, manufactured by Zeon Corporation

### [BR]

NIPOL 1220, manufactured by Zeon Corporation

### [Zinc Oxide]

Zinc Oxide No. 2, manufactured by Sakai Chemical Industry Co., Ltd.

### [Stearic Acid]

STEARIC ACID CHERRY (Appearance; Beads), manufactured by NOF Corporation

### [Anti-Aging Agent]

ANTIGEN 6C, manufactured by Sumitomo Chemical Co., Ltd.

[Carbon Black (i)]

FEF-class carbon black (SEAST SO, manufactured by Tokai Carbon Co., Ltd., iodine adsorption number: 44 mg/g, DBP oil absorption number: 115 ml/100 g)

[Carbon Black (ii)]

FT-class carbon black (SEAST TA, manufactured by Tokai Carbon Co., Ltd., iodine adsorption number: 18 mg/g, DBP oil absorption number: 42 ml/100 g)

[Silica (i)]

NIPSIL VN3, manufactured by Tosoh Silica Corporation, BET specific surface area: 200 m²/g

[Silica (ii)]

NIPSIL ER, manufactured by Tosoh Silica Corporation, BET specific surface area: 100 m²/g

### [Process Oil]

SUNTHENE 410, manufactured by Japan Sun Oil Company, Ltd.

[Hydrazide Compound (i)]

Isophthalic dihydrazide (IDH), manufactured by Otsuka Chemical Co., Ltd.

[Hydrazide Compound (ii)]

Adipic acid dihydrazide (ADH), manufactured by Otsuka Chemical Co., Ltd.

[Hydrazide compound (iii)]

3-Hydroxy-2-naphthoic acid hydrazide (HNH), manufactured by Otsuka Chemical Co., Ltd.

### [Silane Coupling Agent]

NXT Z45, manufactured by Momentive

[Disulfide Compound (i)]

Dithiodicaprolactam (DTDC) (RHENOGRAN CLD-80, manufactured by LANXESS)

[Disulfide Compound (ii)]

4,4′-Dithiodimorpholine (DTDM) (VULNOC R, manufactured by Ouchi Shinko Chemical Industrial Co., Ltd.)

[Vulcanization Accelerator (i)]

SANCELER CZ-G, manufactured by Sanshin Chemical Industry Co., Ltd.

[Vulcanization accelerator (ii)]

SANCELER TT-G, manufactured by Sanshin Chemical Industry Co., Ltd.

### [Sulfur]

Sulfur, manufactured by Karuizawa smelter

### Examples 1 to 15 and Comparative Examples 1 and 2

The individual materials described above were blended and kneaded at fractions shown in Table 1 and Table 2 shown below, thereby preparing vibration isolation rubber compositions. It should be noted that the materials were kneaded by, first, kneading the materials other than the vulcanizing agent (sulfur) and the vulcanization accelerator using a Banbury mixer at 140° C. for five minutes, then, blending the vulcanizing agent and the vulcanization accelerator, and kneading the components using an open roll at 60° C. for five minutes.

Individual properties were evaluated according to the following standards using the vibration isolation rubber compositions of the examples and the comparative examples obtained as described above. The results are collectively shown in Table 1 and Table 2 shown below.

<<Dynamic Magnification Factor>>

Each vibration isolation rubber composition was press-molded (vulcanized) under conditions of 160° C. for 20 minutes, thereby producing a test piece. In addition, the static spring constant (Ks) of the test piece was measured according to JIS K 6394. In addition, the storage spring constant (Kd100) at a frequency of 100 Hz of the test piece was obtained according to JIS K 6385. In addition, a value obtained by dividing the storage spring constant (Kd100) by the static spring constant (Ks) was regarded as the dynamic magnification factor (Kd100/Ks).

The measurement values of the dynamic magnification factors in the individual examples and the individual comparative examples were converted to indexes with an assumption that the measurement value of the dynamic magnification factor (Kd100/Ks) in Comparative Example 1 was regarded as 100 and are shown in Table 1 and Table 2. In addition, index values that were smaller than 95% of the dynamic magnification factor in Comparative Example 1 were evaluated as “0”, and index values that were 95% or more were evaluated as “X”.

<<Heat Resistance>>

Each vibration isolation rubber composition was press-molded (vulcanized) under conditions of 160° C. for 20 minutes, thereby producing a test piece. In addition, the initial elongation at breaking (Eb) was measured in an atmosphere (23° C.) according to JIS K 6251. Next, the produced test piece was left to stand in a high-temperature atmosphere (100° C.) for 70 hours (heat-aging test), and then the elongation at breaking (Eb) was measured in the same manner as described above. In addition, the decrease rate (ΔEb) of the elongation at breaking after the heat-aging test with respect to the initial elongation at breaking was calculated.

Additionally, in the evaluation of the heat resistance, test pieces having a value of the decrease rate (ΔEb) of smaller than 25% were evaluated as “0”, test pieces having a value of 25% or larger and smaller than 27% were evaluated as “Δ”, and test pieces having a value of 27% or larger were evaluated as “X”.

TABLE 1
(Parts by weight)

| | Examples | | | | | | | | | |
|---|---|---|---|---|---|---|---|---|---|---|
| | 1 | 2 | 3 | 4 | 5 | 6 | 7 | 8 | 9 | 10 |
| NR | 100 | 100 | 100 | 100 | 100 | 100 | 100 | 100 | 100 | 100 |
| IR | — | — | — | — | — | — | — | — | — | — |
| BR | — | — | — | — | — | — | — | — | — | — |
| Zinc oxide | 5 | 5 | 5 | 5 | 5 | 5 | 5 | 5 | 5 | 5 |
| Stearic acid | 2 | 2 | 2 | 2 | 2 | 2 | 2 | 2 | 2 | 2 |
| Anti-aging agent | 1 | 1 | 1 | 1 | 1 | 1 | 1 | 1 | 1 | 1 |
| Carbon black (i) | 40 | 40 | 40 | 40 | 40 | 40 | — | 40 | 40 | — |
| Carbon black (ii) | — | — | — | — | — | — | 40 | — | — | — |
| Silica (i) | — | — | — | — | — | — | — | — | — | 40 |
| Silica (ii) | — | — | — | — | — | — | — | — | — | — |
| Process oil | 3 | 3 | 3 | 3 | 3 | 3 | 3 | 3 | 3 | 3 |
| Hydrazide compound (i) | — | — | — | 1 | — | — | — | — | — | — |
| Hydrazide compound (ii) | 1 | 0.3 | 3 | — | 1 | 1 | 1 | 1 | — | — |
| Hydrazide compound (iii) | — | — | — | — | — | — | — | — | 1 | 1 |
| Silane coupling agent | — | — | — | — | — | — | — | — | — | 1 |
| Disulfide compound (i) | 1 | 1 | 1 | 1 | 0.5 | 3 | 1 | — | 1 | 1 |
| Disulfide compound (ii) | — | — | — | — | — | — | — | 1 | — | — |
| Vulcanization accelerator (i) | 1 | 1 | 1 | 1 | 1 | 1 | 1 | 1 | 1 | 1 |
| Vulcanization accelerator (ii) | 0.5 | 0.5 | 0.5 | 0.5 | 0.5 | 0.5 | 0.5 | 0.5 | 0.5 | 0.5 |
| Sulfur | 1 | 1 | 1 | 1 | 1 | 1 | 1 | 1 | 1 | 1 |
| Dynamic magnification | 90 | 94 | 91 | 87 | 92 | 88 | 85 | 91 | 92 | — |
| factor(index) | | | | | | | | | | |
| Evaluation | ◯ | ◯ | ◯ | ◯ | ◯ | ◯ | ◯ | ◯ | ◯ | ◯ |
| Heat resistance | 18 | 17 | 21 | 16 | 12 | 23 | 18 | 19 | 18 | 15 |
| (ΔEb (%)) | | | | | | | | | | |
| Evaluation | ◯ | ◯ | ◯ | ◯ | ◯ | ◯ | ◯ | ◯ | ◯ | ◯ |

TABLE 2
(Parts by weight)

| | | | | | | Compar- | |
|---|---|---|---|---|---|---|---|
| | | | | | | ative | |
| | Examples | | | | | Example | |
| | 11 | 12 | 13 | 14 | 15 | 1 | 2 |
| NR | 100 | 100 | 80 | 80 | 100 | 100 | 100 |
| IR | — | — | 20 | — | — | — | — |
| BR | — | — | — | 20 | — | — | — |
| Zinc oxide | 5 | 5 | 5 | 5 | 5 | 5 | 5 |
| Stearic acid | 2 | 2 | 2 | 2 | 2 | 2 | 2 |
| Anti-aging agent | 1 | 1 | 1 | 1 | 1 | 1 | 1 |
| Carbon black (i) | — | 20 | 40 | 40 | 40 | 40 | 40 |
| Carbon black (ii) | — | — | — | — | — | — | — |
| Silica (i) | — | 20 | — | — | — | — | — |
| Silica (ii) | 40 | — | — | — | — | — | — |
| Process oil | 3 | 3 | 3 | 3 | 3 | 3 | 3 |
| Hydrazide compound (i) | — | — | — | — | — | — | — |
| Hydrazide compound (ii) | — | 1 | 1 | 1 | 1 | — | 1 |
| Hydrazide compound (iii) | 1 | — | — | — | — | — | — |
| Silane coupling agent | 1 | 1 | — | — | — | — | — |
| Disulfide compound (i) | 1 | 1 | 1 | 1 | 5 | 1 | — |
| Disulfide compound (ii) | — | — | — | — | — | — | — |
| Vulcanization | 1 | 1 | 1 | 1 | 1 | 1 | 1 |
| accelerator (i) | | | | | | | |
| Vulcanization | 0.5 | 0.5 | 0.5 | 0.5 | 0.5 | 0.5 | 0.5 |
| accelerator (ii) | | | | | | | |
| Sulfur | 1 | 1 | 1 | 1 | 1 | 1 | 1 |
| Dynamic magnification | 91 | 93 | 91 | 88 | 87 | 100 | 95 |
| factor (index) | | | | | | | |
| Evaluation | ◯ | ◯ | ◯ | ◯ | ◯ | X | X |
| Heat resistance | 17 | 16 | 16 | 13 | 25 | 17 | 20 |
| (ΔEb (%)) | | | | | | | |
| Evaluation | ◯ | ◯ | ◯ | ◯ | Δ | ◯ | ◯ |

From the results in Table 1 and Table 2, it was found out that the vibration isolation rubber compositions of the examples satisfied both a low dynamic magnification factor and heat resistance.

In contrast, it was found out that the vibration isolation rubber composition of Comparative Example 1 contained the specific disulfide compound that is used in the present disclosure, but did not contain the hydrazide compound and had a higher dynamic magnification factor than the dynamic magnification factor in the examples. The vibration isolation rubber composition of Comparative Example 2, similar to Example 1, contained the hydrazide compound, but did not contain the specific disulfide compound that is used in the present disclosure and had poorer heat resistance than the heat resistance in Example 1. Furthermore, the dynamic magnification factor was not sufficiently reduced compared with the dynamic magnification factors in all of the examples.

It should be noted that, in the examples, specific forms in the present disclosure have been described, but the examples are simply examples and shall not be interpreted to limit the present disclosure. It is intended that a variety of deformations that are clear to a person in the art are within the scope of the present disclosure.

### INDUSTRIAL APPLICABILITY

The vibration isolation rubber composition of the present disclosure is preferably used as a material for configuration members (vibration isolation rubber members) such as engine mounts, stabilizer bushes, suspension bushes, motor mounts, subframe mounts, and the like that are used for the vehicles of automobiles or the like and, furthermore, can also be used as a material for configuration members (vibration isolation rubber members) of vibration control apparatuses and seismic isolation apparatuses such as vibration control dampers for computer hard disks, vibration control dampers for general household appliances such as washing machines, vibration control walls for buildings in the construction and housing field, and vibration control dampers.

1. A vibration isolation rubber composition, comprising:
components (B) to (E) below together with a rubber compound made of (A) below,
(A) a diene-based rubber containing natural rubber as a main component,
(B) a filler,
(C) a hydrazide compound,
(D) a disulfide compound represented by General Formula (1), and 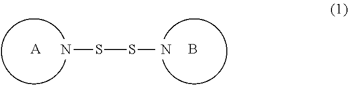
[in General Formula (1), a ring A and a ring B each represent a nitrogen-containing heterocyclic group having 4 to 24 carbon atoms]
(E) A sulfur-based vulcanizing agent.

2. The vibration isolation rubber composition according to claim 1,
wherein a content fraction of the hydrazide compound (C) is within a range of 0.01 to 5.0 parts by weight with respect to 100 parts by weight of the diene-based rubber (A).

3. The vibration isolation rubber composition according to claim 1,
wherein a content fraction of the disulfide compound (D) is within a range of 0.3 to 5.0 parts by weight with respect to 100 parts by weight of the diene-based rubber (A).

4. The vibration isolation rubber composition according to claim 1,
wherein a weight ratio (C:D) between the hydrazide compound (C) and the disulfide compound (D) is 1:60 to 50:1.

5. The vibration isolation rubber composition according to claim 1,
wherein the hydrazide compound (C) is a dihydrazide compound represented by General Formula (2), 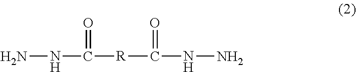
[in General Formula (2), R represents an alkylene group having 1 to 30 carbon atoms, a cycloalkylene group having 3 to 30 carbon atoms, or a phenylene group].

6. The vibration isolation rubber composition according to claim 1,
wherein the hydrazide compound (C) is at least one selected from adipic acid dihydrazide and isophthalic dihydrazide.

7. The vibration isolation rubber composition according to claim 1,
wherein the disulfide compound (D) is at least one selected from 4,4′-dithiodimorpholine and dithiodicaprolactam.

8. The vibration isolation rubber composition according to claim 1,
wherein a content fraction of the filler (B) is within a range of 5 to 100 parts by weight with respect to 100 parts by weight of the diene-based rubber (A).

9. The vibration isolation rubber composition according to claim 1,
wherein the filler (B) is at least one selected from the group consisting of carbon black and silica.

10. The vibration isolation rubber composition according to claim 1,
wherein the filler (B) is FEF-class carbon black.

11. The vibration isolation rubber composition according to claim 1,
wherein the filler (B) is made up of carbon black and silica, and a weight ratio between carbon black and silica is 8:2 to 2:8.

12. A vibration isolation rubber member that is made of a vulcanized body of the vibration isolation rubber composition according to claim 1.
